(19) United States
(12) Patent Application Publication
(10) Pub. No.: US 2010/0190056 A1
(43) Pub. Date: Jul. 29, 2010

(54) Battery Tab Structure

(75) Inventors: Joseph C. Turner, Henderson, NV (US); Stewart G. Graham, Henderson, NV (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: K2 ENERGY SOLUTIONS, INC,, Henderson, NV (US)

(21) Appl. No.: 12/695,482

(22) Filed: Jan. 28, 2010

Related U.S. Application Data
(60) Provisional application No. 61/147,896, filed on Jan. 28, 2009.

(51) Int. Cl. H01M 4/02; H01M 4/82

(52) U.S. Cl. 429/211; 29/623.1

(57) ABSTRACT

Cathode and anode structures for a battery each include one or more tabs welded to a substrate. A method of making a battery may include providing tabs welded to a substrate of each of a cathode and anode of the battery. Tabs for a cathode or anode structure may be provide from the same or similar material as the substrate of a corresponding cathode or anode.

### CROSS-REFERENCE TO RELATED APPLICATIONS

This patent claims the benefit of U.S. Provisional Patent Application No. 61/147,896, filed Jan. 28, 2009.

### TECHNICAL FIELD

This patent relates to tabs for secondary battery cells, compositions for tabs for secondary battery cells and methods of making and attaching tabs for secondary battery cells.

### BACKGROUND

Batteries find numerous uses from powering consumer electronic products such as cell phones, computers and tools, to powering electric and hybrid-electric vehicles, as well as providing power to mobile rocket launchers.

A typical battery cell 1, as shown in FIG. 1, consists of a cathode plate 102, an anode plate 104, a separator 106 disposed between the cathode and anode plates, an electrolyte 108 disposed between the cathode and anode plates and current collectors or tabs 110, 112 coupled to the cathode and anode plates 102, 104, respectively.

Various configurations of the battery cell include prismatic, button and cylindrical. In a cylindrical cell construction, such as a cylindrical cell 2 shown in FIG. 2, a cathode plate 202, an anode plate 204 and separators 206 are rolled around a center pin 218 into a cylinder 220. A current collector or tab 208 is disposed on the cathode, and a current collector or tab 210 is disposed on the anode. The collector 208 is electrically coupled to a conductive cathode cover 212. Similarly, the collector 210 is electrically coupled to an anode cover 214, which may also form the container for the cell within which the cylinder roll 220 is disposed. An insulator/spacer 216 separates the anode cover 214 from the cathode cover 212, and an insulator 222 insulates the cylinder roll 220 from the anode cover 214. A vent 224 may be provided as required by the cell chemistry.

Numerous battery chemistries exist. Owing to its high charge density and charge/life cycle characteristics, lithium ion based chemistries are frequently favored over lead-acid; nickel-cadmium (NiCad), or nickel-metal hydride (NiMH) chemistries. Lithium-ion batteries (sometimes referred to as Li-ion batteries) are a type of rechargeable battery in which a lithium ion moves between the anode and the cathode. Lithium ions move from the anode to the cathode while discharging and from the cathode to the anode while charging. The current collectors act to couple charge carriers, electrons from/to the anode and the cathode.

While the current collectors, sometimes referred to as tabs or leads, do not form part of the cell chemistry, the number, structure, composition and location of the tabs can have great effect on the efficiency of the battery cell. Efficiency may be measured in terms of charge/discharge rates (i.e., power cells), maximum charge potential (i.e., energy cells), charge utilization and the like.

### BRIEF DESCRIPTION OF THE DRAWINGS

FIG. 1 is a schematic of a typical lithium ion battery cell.

FIG. 2 is a schematic of a typical cylindrical form battery cell.

FIG. 3 schematically illustrates an anode/cathode pair in accordance with an embodiment of the invention.

FIG. 4 schematically illustrates an anode/cathode pair in accordance with an embodiment of the invention.

FIG. 5 schematically illustrates an anode/cathode pair in accordance with an embodiment of the invention.

FIG. 6 schematically illustrates an anode/cathode pair in accordance with an embodiment of the invention.

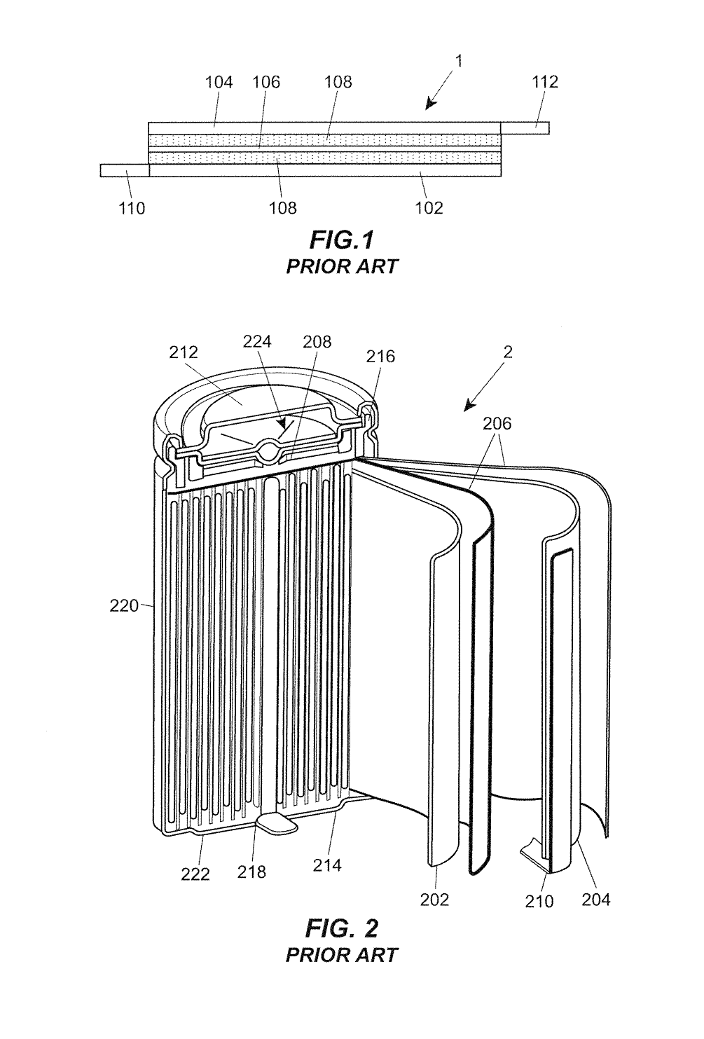

### DETAILED DESCRIPTION

While this invention is susceptible of embodiment in many different forms, there will be described herein in detail, specific embodiments thereof with the understanding that the present disclosure is to be considered as an exemplification of the principles of the invention and is not intended to limit the invention to the specific embodiments illustrated.

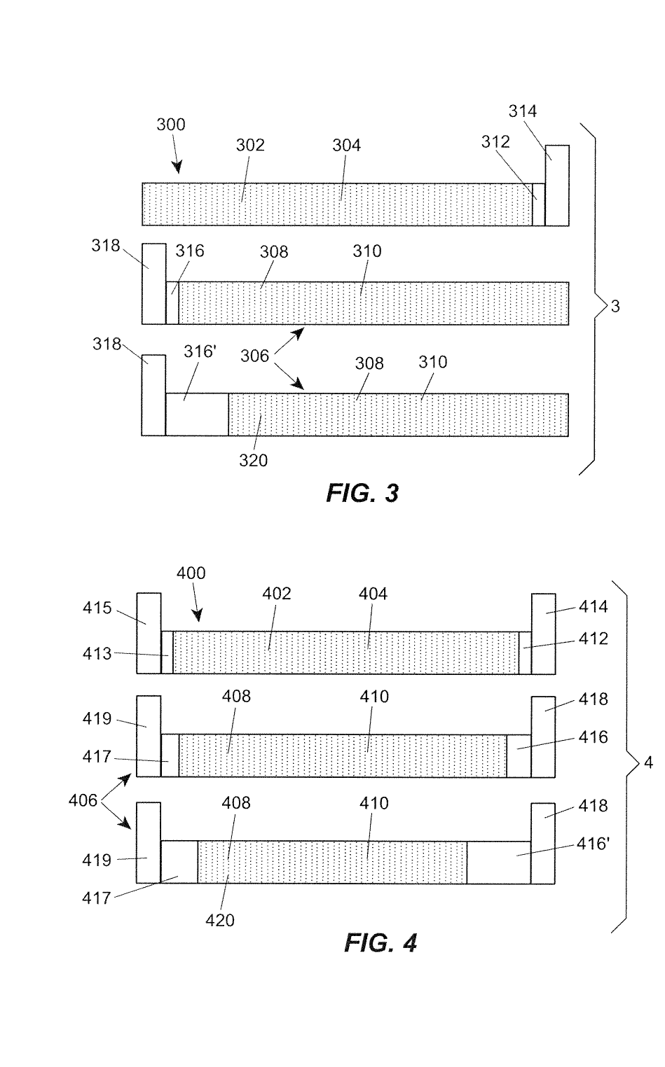

FIG. 3 illustrates an anode/cathode pair 3 in accordance with an embodiment of the invention that may be used to form corresponding electrodes of a battery cell and in particular that may be used to form electrodes of a cylindrical lithium ion battery cell. A cathode 300 may include a metal foil substrate 302 onto which an active material 304 is disposed. An anode 306 may include a metal foil substrate 308 onto which an active material 310 is disposed.

The cathode substrate 302 may be an aluminum or an aluminum alloy foil. The anode substrate 308 may be a copper or a copper alloy foil. The cathode active material 304 may be a composition containing predominately lithium iron phosphate, lithium manganese phosphate, lithium cobalt oxide, lithium nickel oxide or other suitable lithium containing materials. The anode active material 310 may be carbon based, for example graphite, although other anode materials, such as lithium metal may be used.

An end 312 of each side of the substrate 302 is free of the active material 304, and a tab 314 is coupled to the end 312. The tab 314 is metallic and conductive, and for example, the tab 314 may be the same or similar metallic foil as forms the substrate 302. The tab 314 may be coupled by welding to the end 312, and for example, the tab 314 may be coupled by sonic welding to the end 312.

An end 316 of the substrate 308 is free of the active material 310, and a tab 318 is coupled to the end 316. The tab 318 is metallic and conductive, and for example, the tab 318 may be the same or similar metallic foil as forms the substrate 308. The tab 318 may be coupled by welding to the end 316, and for example, the tab 318 may be coupled by sonic welding to the end 316.

The tabs 314 and 318 may be covered with a tape made of a polyimde material, such as Kapton tape, manufactured by Dupont. The Kapton tape is used primarily because of its high temperature properties. Corresponding tabs of the additional embodiments, described below, may be similarly covered.

In alternative structures, the cathode 300 and the anode 306 may be double-sided, i.e., each side of the respective foil coated with their respective active material. The second side 320 of the anode 306 and in particular the active material-free end 316′ may be extended as compared the end 316. The extended, active material-free end 316′ may facilitate rolling of the cathode 302 and the cathode 306 into a cylinder.

FIG. 4 illustrates an anode/cathode pair 4 in accordance with an embodiment of the invention that may be used to form corresponding electrodes of a battery cell and in particular that may be used to form electrodes of a cylindrical battery cell. The cathode 400 may include a metal foil substrate 402 onto which an active material 404 is disposed. The anode 406 may include a metal foil substrate 408 onto which an active material 410 is disposed.

The cathode substrate 402 may be an aluminum or an aluminum alloy foil. The anode substrate 408 may be a copper or a copper alloy foil. The cathode active material 404 may be a composition containing predominately lithium iron phosphate, lithium manganese phosphate, lithium cobalt oxide, lithium nickel oxide or other suitable lithium containing material. The anode active material 410 may be carbon based, and for example graphite, although other anode materials such as lithium metal may be used.

A first end 412 of the cathode substrate 402 is free of active material 404, and a first cathode tab 414 is coupled to the end 412. A second end 413 is free of active material 404, and a second cathode tab 415 is coupled to the end 413. The cathode tabs 414, 415 may be metallic and conductive and may be the same or similar metallic foil as forms the substrate 304. The cathode tabs 414, 415 may be coupled by welding to the respective ends. For example, the cathode tabs 414, 415 may be coupled by sonic welding to their respective ends.

A first end 416 of the anode substrate 408 is free of active material 410, and a first anode tab 418 is coupled to the first end 416. A second end 417 of the anode substrate 408 is free of active material 410, and a second anode tab 419 is coupled to the second end 417. The tabs 418, 419 may be metallic and conductive and may be made of the same or similar metallic foil as forms the substrate 408. The tabs 418, 419 may be coupled by welding to their respective ends. For example, the tabs 418, 419 may be coupled by sonic welding to their respective ends.

In alternative structures, the cathode 400 and the anode 406 may be double-sided, i.e., each side of the respective foil coated with active material. The second side 420 of the anode 406 and in particular the active material-free end 416′ may be extended as compared the end 416. The extended, active material-free end 416′ may facilitate rolling of the cathode 402 and the cathode 406 into a cylinder.

Disposing tabs at each end of the anode substrate and the cathode substrate provides for the coupling of charges to/from the anode and the cathode, as the case may be, more uniformly.

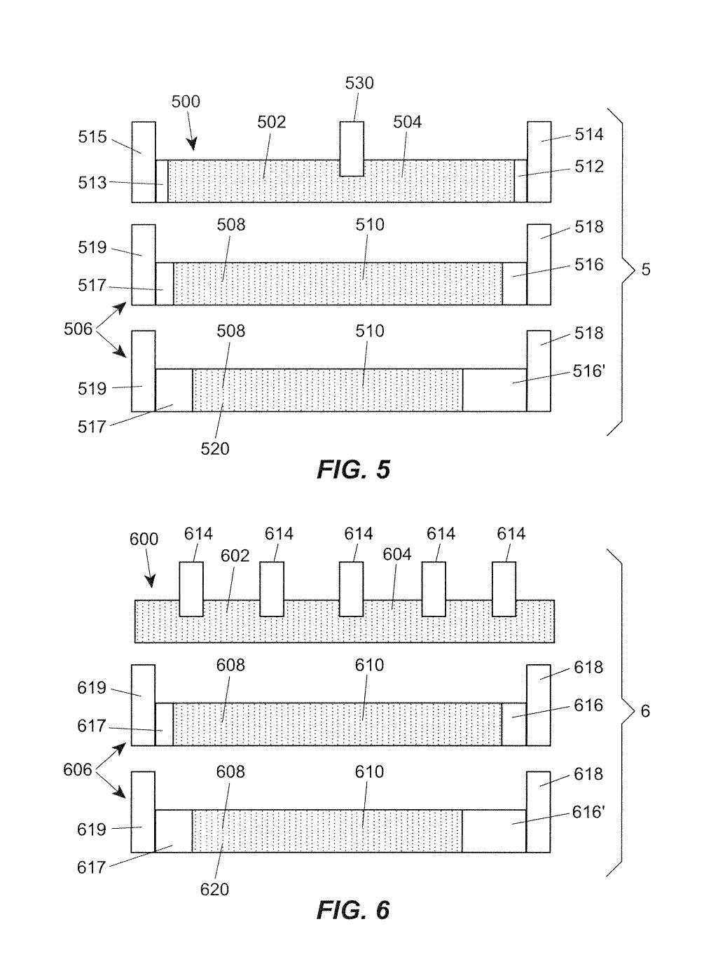

FIG. 5 illustrates an anode/cathode pair 5 in accordance with an embodiment of the invention that may be used to form corresponding electrodes of a battery cell and in particular that may be used to form electrodes of a cylindrical battery cell. The cathode 500 may include a metal foil substrate 502 onto which an active material 504 is disposed. The anode 506 may include a metal foil substrate 508 onto which an active material 510 is disposed.

The cathode substrate 502 may be an aluminum or an aluminum alloy foil. The anode substrate 508 may be a copper or a copper alloy foil. The cathode active material 504 may be a composition containing predominately lithium iron phosphate, lithium manganese phosphate, lithium cobalt oxide, lithium nickel oxide or other suitable lithium containing material. The anode active material 510 may be carbon based, and for example graphite, although other anode materials such as lithium metal may be used.

A first end 512 of the substrate 502 is free of active material 504, and a first cathode tab 514 is coupled to the end 512. A second end 513 is free of active material 504, and a second cathode tab 515 is coupled to the end 513. The cathode tabs 514, 515 may be metallic and conductive and may the same or similar metallic foil as forms the substrate 502. The tabs 514, 515 may be coupled by welding to the respective ends. For example, the tabs 514, 515 may be coupled by sonic welding to their respective ends.

A first end 516 of the anode substrate 508 is free of active material 510, and a first anode tab 518 is coupled to the first end 516. A second end 517 of the substrate 508 is free of active material 510 and a second anode tab 519 is coupled to the second end 517. The tabs 518, 519 may be metallic and conductive and may be the same or similar metallic foil as forms the substrate 508. The tabs 518, 519 may be coupled by welding to their respective ends. For example, the tabs 518, 519 may be coupled by sonic welding to their respective ends.

In alternative structures, the cathode 500 and the anode 506 may be double-sided, i.e., each side of the respective foil coated with active material. The second side 520 of the anode 506 and in particular the active material-free end 516′ may be extended as compared the end 516. The extended, active material-free end 516′ may facilitate rolling of the cathode 502 and the cathode 506 into a cylinder.

The cathode 500 may include one or more additional tabs, tabs 530 disposed along the length of the cathode substrate 502. As shown in FIG. 5, one additional tab 530 is disposed equidistant from each of tabs 514 and 515. More than one additional tab 530 may be provided. If more than one additional tab is provided between the tabs 514 and 515, such tabs may be equally spaced or irregularly spaced. Moreover, while the anode 508 is shown not to include additional tabs, the anode may likewise be formed with additional tabs. The additional tabs 530 may also be of the same or similar metallic foil as the substrate 502. The additional tabs 530 may be welded, such as by sonic welding, to the substrate 502. In any case, in this embodiment as well as embodiments discussed below, there is no active material on the substrate between the substrate and the additional tabs.

Providing tabs at each end of the anode substrate and the cathode substrate provides for the coupling of charges to/from the anode and the cathode, as the case may be, more uniformly. Providing additional intermediate tabs further facilitates uniform charge coupling and transport to and from the cathode/anode.

FIG. 6 illustrates an anode/cathode pair 6 in accordance with an embodiment of the invention that may be used to form corresponding electrodes of a battery cell and in particular that may be used to form electrodes of a cylindrical battery cell. The cathode 600 may include a metal foil substrate 602 onto which an active material 604 is disposed. The anode 606 may include a metal foil substrate 608 onto which an active material 610 is disposed.

The cathode substrate may be an aluminum or aluminum alloy foil. The anode substrate may be a copper or copper alloy foil. The cathode active material may be a composition containing predominately lithium iron phosphate, lithium manganese phosphate, lithium cobalt oxide, lithium nickel oxide or other suitable lithium containing material. The anode active material may be carbon based, and for example graphite.

The cathode 600 includes a plurality of tabs 614 disposed along the length of the cathode substrate 602, however, offset from the ends of the cathode substrate 602. The tabs 614 may be metallic and conductive and may be the same or similar metallic foil as forms the substrate 602. The tabs 614 may be coupled by welding to the cathode substrate 602. For example, the tabs 614 may be coupled by sonic welding to the cathode substrate.

A first end 616 of the substrate 608 is free of active material 610, and a first anode tab 618 is coupled to the first end 616. A second end 617 of the substrate 608 is free of active material 610, and a second anode tab 619 is coupled to the second end 617. The tabs may be metallic and conductive and may be coupled by welding to their respective ends. For example, the tabs 618 and 619 may be coupled by sonic welding to their respective ends.

In alternative structures, the cathode 600 and the anode 606 may be double-sided, i.e., each side of the respective foil coated with active material. The second side 620 of the anode 606 and in particular the active material-free end 616′ may be extended as compared the end 616, which may facilitate forming the cathode 600 and the anode 608 into a cylinder. Moreover, while the cathode 600 is shown to include tabs along the length of the substrate, the anode may likewise be formed with tabs along its length.

Providing tabs spaced along the length of the anode substrate and the cathode substrate provides for the coupling of charges to/from the anode and the cathode, as the case may be, more uniformly. Providing additional intermediate tabs further facilitates uniform charge coupling and transport to/from the cathode/anode.

In any of the foregoing embodiments, the cathode and anode structures may have the following characteristics:

### Cathode:

length: 485-1715 millimeters (mm)

thickness: 0.020±0.002 mm

active material on each side: 81-191 grams/square meter (g/m²)

pressed thickness: 0.113-0.169 mm

density: 2.396-2.593 g/cm²

### Anode:

length: 535-1795 mm

thickness: 0.009±0.002 mm

active material on each side: 53-90 g/m²

pressed thickness: 0.089-0.138 mm

density: 1.325-1.510 g/cm³

anode ratio: 1.14-1.30

Without limiting the generality of the foregoing, the following are examples of suitable combinations of cathode and anode structures for various batteries.

### Example 1

### Type 16340 Energy Cell

### Cathode:

length: 485 mm

thickness: 0.020 mm

active material, each side: 188±3 g/m²

pressed thickness: 0.167±0.002 mm

density: 2.53 g/cm³

number of tabs: 1, at one end

### Anode:

length: 535 mm

thickness: 0.009 mm

active material, each side: 84±3 g/m²

pressed thickness: 0.120±0.002 mm

density: 1.510 g/cm³

anode ratio: 1.30

number of tabs 1, at one end

### Example 2

### Type 26650, Power Cell

### Cathode:

length: 1715 mm

thickness: 0.020 mm

active material, each side: 115±2 g/m²

pressed thickness: 0.116±0.003 mm

density: 2.396 g/cm³

number of tabs: 2, one at each end

### Anode:

length: 1795 mm

thickness: 0.009 mm

active material, each side: 55±2 g/m²

pressed thickness: 0.092±0.003 mm

density: 1.325 g/cm³

anode ratio: 1.14

number of tabs 2, one at each end

### Example 3

### Type 18650, Eenergy Cell

### Cathode:

length: 590 mm

thickness: 0.020 mm

active material, each side: 188±2 g/m²

pressed thickness: 0.167±0.002 mm

density: 2.560 g/cm³

number of tabs: 2, one at each end,

### Anode:

length: 645 mm

thickness: 0.009 mm

active material, each side: 84±3 g/m²

pressed thickness: 0.133±0.002 mm

density: 1.350 g/cm³

anode ratio: 1.25

number of tabs 2, one at each end

### Example 4

### Type 26650, Energy Cell

### Cathode:

length: 1225 mm

thickness: 0.020 mm

active material, single side: 188±3 g/m³

active material, double side: 376±4 g/m

pressed thickness: 0.165±0.003 mm

density: 2.593 g/cm³

number of tabs: 3, one at each end, and one equidistant between ends

### Anode:

length: 1305 mm

tickness: 0.009 mm

active material, single side: 86±3 g/m³

active material, double side: 172±4 g/m

pressed thickness: 0.141±0.003 mm

density: 1.303 g/cm³

anode ratio: 1.28

number of tabs 2, one at each end

### Example 5

### 26650 Power Cell

### Cathode:

length: 1715 mm

thickness: 0.020 mm

active material, each side: 115±2 g/m²

pressed thickness: 0.116±0.003 mm

density: 2.396 g/cm³

number of tabs: 4 or 5, spaced equidistant, offset from the ends

### Anode:

length: 1795 mm

thickness: 0.009 mm

active material, each side: 55±2 g/m²

pressed thickness: 0.092±0.003 mm

density: 1.325 g/cm³

anode ratio: 1.28

number of tabs 3, one at each end and one equidistant between the ends

While the foregoing describes specific embodiments, and particular combinations of structures, the structures may be combined in numerous additional ways. Single or multiple tab cathode structures may be combined with other single or multiple tab anode structures. Cathode structures of various active material quantity and density may be combined with anode structures of various active material quantity and density, with the number of placing of tabs corresponding thereto. Thus, the foregoing provides suitable ranges and examples without exhausting all possible examples, configurations or combinations of structures.

As noted, any of the foregoing embodiments may be rolled into a cylinder to form a battery cell, such as the cell 200. However, other cell configurations such as prismatic, button or the like make be formed using cathode and anode structures as described herein.

The tabs have been described as the same or similar metallic foil as the respective substrate. The tabs may be constructed of virtually any conductive material that may be reliably joined to the substrate that permits conducting charges from the substrate. Preferably, the tabs are a material that may be easily joined to the substrate, such as by welding. Furthermore, the number and placement of tabs on the cathode and anode structures may done so as to facilitate and enhance charge transport to/from the anode and cathode for the given anode/cathode structure and active material compositions.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

1. An electrode for a battery cell comprising:
a substrate;
an active material disposed on the substrate; and
a plurality of current collector tabs coupled to the substrate, the number and placement of tabs on the substrate being selected based at least upon characteristics of the active material and the composition of the substrate.

2. The electrode of claim 1 including a single tab coupled to an end of the substrate.

3. The electrode of claim 1 including a tab coupled to each end of the substrate.

4. The electrode of claim 1 including at least three tabs spaced along a length of the substrate.

5. The electrode of claim 4 wherein the three tabs are spaced equidistantly along the length of the substrate.

6. The electrode of claim 1 wherein the tabs are welded to the substrate.

7. The electrode of claim 6 wherein the tabs are sonically welded to the substrate.

8. The electrode of claim 1 wherein the tabs comprise metallic foil.

9. The electrode of claim 8 wherein the substrate comprises a metallic foil.

10. The electrode of claim 1 wherein the electrode is one of a cathode or an anode.

11. A cathode/anode pair for use in a battery cell, comprising:
a cathode of the cathode/anode pair comprising a cathode substrate having an active material disposed thereon and a plurality of cathode current collector tabs coupled to the cathode substrate; and
an anode of the cathode/anode pair comprising a cathode substrate having an active material disposed thereon and an end of the cathode substrate is free of active material and an anode current collector tab is coupled to the end.

12. A method of making an electrode for a battery cell, the method comprising:
selecting a number of current collector tabs for the electrode based at least upon characteristics of the active material and the composition of the substrate;
selecting locations for the tabs on the substrate based at least upon characteristics of the active material and the composition of the substrate; and
coupling the selected number of tabs to the selected locations on the substrate.

13. The method of claim 12, wherein the tabs are formed of a same or similar material as the substrate.

14. The method of claim 11 including coupling the selected number of tabs to the selected locations on the substrate via welding.

15. The method of claim 11 including coupling the selected number of tabs to the selected locations on the substrate via sonic welding.
